(19) United States
(12) Patent Application Publication
(10) Pub. No.: US 2026/0028859 A1
(43) Pub. Date: Jan. 29, 2026

(54) DRIVE UNIT FOR MOTOR VEHICLE APPLICATIONS

(71) Applicant: Kiekert Aktiengesellschaft, Heiligenhaus (DE)

(72) Inventors: Tobias STEFFEN, Essen (DE); Carsten FUCHS, Essen (DE); Christina NOBLES, Dinslaken (DE); Andreas SCHMITZ, Velbert (DE); Ömer INAN, Dorsten (DE); Peter SZEGENY, Engelskirchen (DE)

(73) Assignee: Kiekert Aktiengesellschaft, Heiligenhaus (DE)

(21) Appl. No.: 18/994,650

(22) PCT Filed: Jun. 13, 2023
(86) PCT No.: PCT/DE2023/100446

§ 371 Date: Jan. 28, 2025

(30) Foreign Application Priority Data
Jul. 20, 2022 (DE) 10 2022 118 120.0

(51) Int. Cl. E05B 81/06; E05B 81/14; E05B 81/30; E05B 81/34; F16H 1/12

(52) U.S. Cl. CPC E05B 81/06; E05B 81/14; E05B 81/30; E05B 81/34; F16H 1/125

(57) ABSTRACT

The invention relates to a drive unit for motor vehicle applications, which is equipped with an electromotive drive (6, 7, 8) having an electric motor (6) and a drive wheel (8). In addition, an actuating element (5) which is acted upon by the drive wheel (8) is provided. A crown gear transmission stage is implemented between a pinion (7) on an output shaft of the electric motor (6) and the drive wheel (8). According to the invention, the drive wheel (8) has a spiral contour (9) and/or toothed contour (11) for acting on the actuating element (5).

The invention relates to a drive unit for motor vehicle applications, with an electromotive drive having an electric motor and drive wheel, and with an actuating element acted upon by the drive wheel, wherein a crown gear transmission stage is implemented between a pinion on an output shaft of the electric motor and the drive wheel.

Drive units for motor vehicle applications are typically operated with low-voltage direct current of, for example, 12 V, 24 V, or even 48 V. Common areas of application for such drive units are that mirrors, window panes, but also door wings, tailgates, etc., can be moved and actuated with their assistance. Furthermore, with their assistance, seats can also be adjusted, headlights can set, or flaps for electrical connection devices can also be locked.

In addition, such drive units are particularly advantageous when used in conjunction with motor vehicle latches. In such a case, the drive unit in question is actually located in the interior of a housing or lock housing. With their assistance, different functions can be controlled such as “locked/unlocked,” “theft-proof/theft-unlocked,” and “child-proof/child-locked.” In addition, such drive units are advantageously used for so-called “electric opening.” In this case, the actuating element acted upon by the drive wheel acts directly or indirectly upon a pawl when the locking mechanism is closed and ensures that the pawl is lifted from its latching engagement with the rotary latch. As a result, the locking mechanism and therefore the motor vehicle latch change to their open state.

Such drive units often work with a high transmission ratio or reduction ratio in order to be able to transmit large forces-for example, in conjunction with a window lifter. In addition, a compact design is generally required, because the installation conditions are typically cramped. For this reason, the generic prior art according to DE 10 2020 102 362 A1 already proposes a drive unit for motor vehicle applications in which the drive train has at least one crown gear stage. For this purpose, the pinion on the output shaft of the electric motor and the drive wheel are arranged at an angle, and in particular at right angles, to each other, so that the crown gear transmission stage is implemented in this way.

A comparable drive unit for motor vehicle applications is pursued in DE 10 2017 211 803 A1. This is an angular gear designed as a crown gear. The output wheel can be designed as a plastic injection-molded part in order to achieve not only a high level of efficiency, but also particularly simple and economical production.

The prior art has proven itself in principle, but still offers room for further improvement. Hence, for example, the installation space in the interior of a lock housing to accommodate a motor vehicle latch is extremely limited. At the same time, high forces are required on the output side of the actuating element if, for example, a locking mechanism consisting of a rotary latch and a pawl is to be opened by an electric motor. The solutions proposed at this point in the prior art have proven successful, but still offer room for further improvements.

Accordingly, the invention is based upon the technical problem of further developing such a drive unit for motor vehicle applications in such a way that the highest possible transmission or reduction ratio can be realized while taking into account a compact and economical design.

To solve this technical problem, the invention proposes, starting from a generic drive unit within the framework of a first variant of the invention, that the drive wheel have a spiral contour for acting upon the actuating element. In a second variant of the invention, in conjunction with a generic drive unit, a toothed contour is provided for acting upon the positioning element, instead of the spiral contour. In principle, the spiral contour and the toothed contour can also be combined with one another.

The spiral contour is advantageously located on a surface, opposite a crown toothing, of the drive wheel. In contrast, the toothed contour is usually arranged on the surface, equipped with the crown toothing, of the drive wheel. This means that the drive wheel is first of all and according to the invention equipped on one of its surfaces with the crown toothing in which the pinion on the output shaft of the electric motor engages. On the opposite surface or on the same surface of the mostly disc-shaped or circular disc-shaped drive wheel, however, the spiral contour or toothed contour is provided. The spiral contour is a helical spiral surface which is wound around an axis or axis of rotation of the drive wheel and extends from a low point as the starting point of the spiral contour to a high point of the spiral contour. In contrast, the toothed contour is usually placed centrally compared to the drive wheel, i.e., both axes of rotation coincide. This ultimately also applies in the case of the spiral contour, in which the spiral axis coincides with the axis or axis of rotation of the drive wheel.

The actuating element is generally a pivoting lever rotatably mounted about an axis. The axis is usually defined by a bearing pin, standing mostly vertically on a housing cover, for the pivot lever. The design can be such that the axis of the drive wheel and the axis of the pivot lever are arranged largely perpendicular to each other. Such an embodiment is usually realized in conjunction with the spiral contour. However, if a toothed contour is provided which typically interacts with an associated toothed contour on the pivot lever or actuating element, an alternative approach is for the axis of the drive wheel and the axis of the pivot lever or actuating element to run largely parallel to one another.

In the case of the realized spiral contour, the approach, in a further embodiment, can be such that the pivot lever rests with a stop on the head side against the spiral contour. Furthermore, the approach is such that the spiral contour in an undeflected end position at least partially overlaps the pivot lever. This undeflected end position of the pivot lever corresponds to the fact that the head-side stop of the pivot lever rests at the lowest point of the spiral contour. Since, in this undeflected end position, the spiral contour at least partially overlaps the pivot lever, a stop or end stop is defined in this way. An additional stop in this undeflected end position of the pivot lever is therefore expressly not required, which reduces the effort and increases the compactness of the solution according to the invention.

In the case of the variant with the toothed contour, the design is advantageously such that the toothed contour is provided as a central pinion on the drive wheel. This central pinion usually engages with a gear wheel arch on the actuating element or pivot lever. In this way, a desired transmission ratio between the central pinion on the one hand and the gear wheel arch on the other can be realized and implemented. In addition, such a gear wheel arch can easily be realized and implemented on the actuating element or pivot lever, which is usually made of plastic. Finally, the gear wheel arch is usually equipped with a stop at the end to limit the pivoting movement of the actuating element or pivot lever if necessary. Both described variants are characterized by their particularly compact design. This can be attributed to the fact that the pivot lever or the actuating element at least partially overlaps the drive wheel.

In addition, the approach is usually such that the electric motor with its output shaft and the pinion there describe a predominantly right angle of engagement with the drive wheel with the crown toothing. In general, both the pinion and the crown toothing can be designed as straight toothing. However, it is particularly advantageous if helical toothing is used at this point. In addition, an evoloid toothing can be advantageously implemented in order to provide particularly high gear ratios.

Furthermore, the design is advantageously such that the electric motor with its output shaft has a longitudinal extension which forms an acute angle with the axis of the pivot lever, if the variant with the spiral contour is considered. In conjunction with the variant using the toothed contour, the design is typically such that the electric motor with its output shaft has a longitudinal extension that is predominantly oriented tangentially in comparison to the gear wheel arch on the actuating element or pivot lever. In addition, both variants are characterized in that the electric motor with its output shaft and the longitudinal extension determined thereby is oriented towards the axis or the center of the disc-like drive wheel. Finally, it has proven to be particularly advantageous if at least the drive wheel and the actuating element are each designed or aligned as plastic injection-molded parts.

As a result, a drive unit for motor vehicle applications is, in the context of the invention, provided which has a particularly compact design and at the same time offers high transmission ratios or reduction ratios. At the same time, the entire unit is associated with economical production. Furthermore, since the crown gear transmission stage between the pinion on the output shaft of the electric motor and the drive wheel for acting upon the actuating element allows a certain axial play, installation is also made easier, and long-term functional reliability is ensured. The axial freedom achieved in this way makes the crown gear transmission stage insensitive to manufacturing and assembly errors as well as any housing deformations.

The crown gear transmission stage, in connection with the respective helical gearing of both the pinion as well as the crown toothing on the drive wheel usually implemented at this point, ensures that a high gear ratio for acting upon the actuating element is implemented. This is especially true if the crown gear transmission stage is the only transmission stage of the drive unit according to the invention.

In this regard, the invention also makes use of the fact that the spiral contour on the drive wheel can in principle realize more than a pivoting movement of the actuating element or pivoting lever. In this context, it is, moreover, additionally and advantageously conceivable that the spiral contour include a different pitch and consequently, seen over its course, a varying angle with the axis of the drive wheel. As a rule, however, the spiral contour works with a constant gradient so that, with its help, the overall rotary movement of the drive wheel is converted into a rotary movement of the pivot lever about an axis perpendicular thereto. This promotes a compact design and at the same time provides the end stop in the undeflected end position of the pivot lever.

Comparable advantages and effects are observed in the variant with the toothed contour. In this case as well, the rotary movement of the drive wheel is converted into a rotary movement of the pivot lever with a practically variable or constant ratio. The overlap observed at this point between the actuating element or pivot lever on the one hand and the drive wheel on the other also promotes a compact design. These are the main advantages.

In the following, the invention is explained in more detail with the aid of a drawing showing only an exemplary embodiment; in the figures:

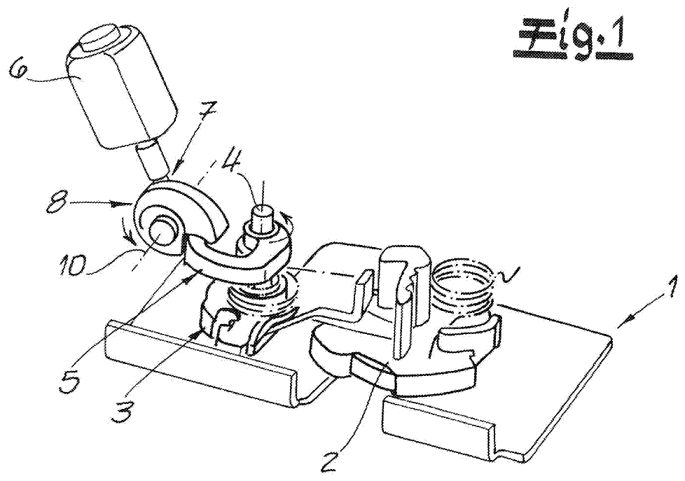

FIG. 1 shows the drive unit according to the invention in connection with a motor vehicle latch for electrically opening a locking mechanism,

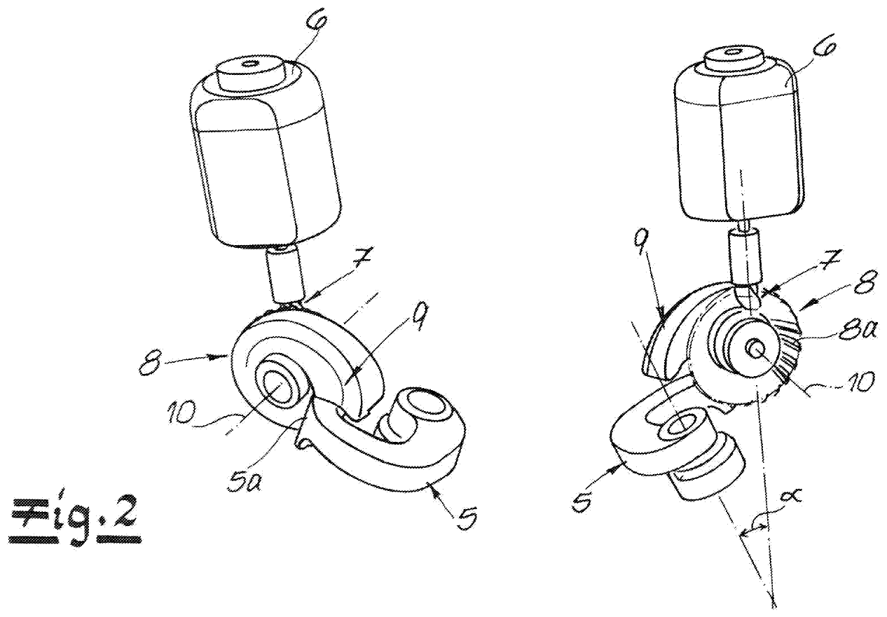

FIG. 2 shows the drive unit in a perspectival front view and rear view, and

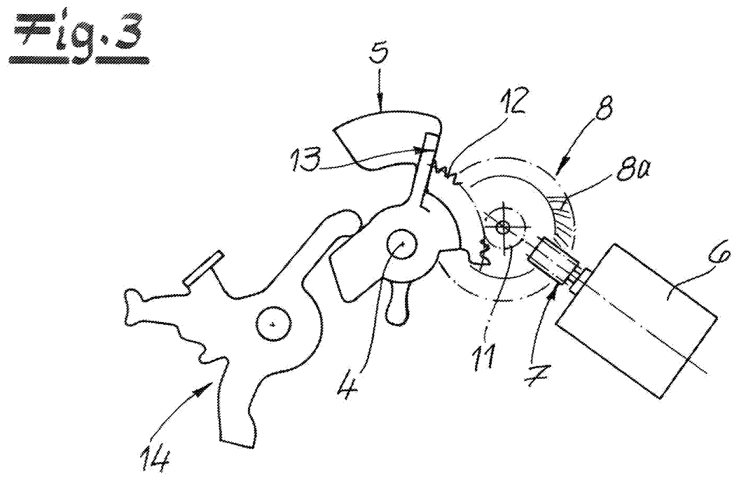

FIG. 3 shows a variant of the drive unit according to the invention.

The figures show a drive unit for motor vehicle applications. In the exemplary embodiment according to FIG. 1, the drive unit is used in conjunction with a motor vehicle latch 1 shown therein. This means that the motor vehicle latch 1 is equipped with the relevant drive unit. For this purpose, the motor vehicle latch 1 has a locking mechanism 2, 3 consisting of a rotary latch 2 and pawl 3 which are each rotatably mounted on a lock case 1. In the context of the exemplary embodiment according to FIG. 1, the axis for the pawl 3 is defined by a bearing pin 4 which for this purpose stands vertically on the lock case 1 or, generally, on a housing cover 1. A release lever 5 is also mounted on the bearing pin 4 axially parallel with the pawl 3.

In the context of the present invention, the release lever 5 is a specially designed actuating element 5 which, in the context of the illustrations, is designed as a pivoting lever 5 rotatably mounted about the axis defined by the bearing pin 4, and specifically as a release lever 5 in the variant according to FIG. 1. The basic structure of the drive unit includes an electromotive drive 6, 7, 8.

The electromotive drive 6, 7, 8 is in turn equipped with an electric motor 6 and a drive wheel 8. In addition, a pinion 7 is realized on an output shaft of the electric motor 6. Between the pinion 7 on the output shaft of the electric motor 6 and the drive wheel 8, a crown gear transmission stage is provided which can best be understood from the right-hand illustration in FIG. 2. In fact, at this point, helical toothing or evoloid toothing are used on the one hand on the pinion 7, and on the other on the drive wheel 8 or a crown toothing 8a on the drive wheel 8.

Furthermore, and in the exemplary embodiment according to FIG. 2, the drive wheel 8 on its surface opposite the crown toothing 8a is equipped with a spiral contour 9. The spiral contour 9 serves to act upon the actuating element 5. In the context of the variant according to FIG. 1, the actuating element 5 is designed as a pivot lever or release lever 5, as already explained. As a result, a rotational movement of the drive wheel 8 about its axis 10 in a counterclockwise direction, as indicated in FIG. 1, causes the release lever 5 there to also perform a pivoting movement in a counterclockwise direction about its axis defined by the bearing pin 4. The counterclockwise rotation of the release lever 5 results in the pawl 3, which is coupled in a rotationally fixed manner to the release lever 5, also being pivoted counterclockwise around the common bearing pin 4 in the example, and thereby leaving its locking position with the rotary latch 2. As a result, the rotary latch 2 can swing open with the assistance of a spring and can release a previously captive locking bolt (not shown). The associated motor vehicle door and the locking mechanism 2, 3 are consequently opened by an electric motor.

By comparing FIGS. 1 and 2, it can be seen that the pivot lever 5 rests with a stop 5a on the head side against the spiral contour 9. According to the exemplary embodiment, the spiral contour 9 has a constant pitch compared to the axis 10 of the drive wheel 8. In principle, an increasing or decreasing pitch can also be used here, depending upon which output force curve is desired.

According to the exemplary embodiment, the crown gear transmission stage between the pinion 7 and the drive wheel 8 or the crown toothing 8a there represents the only transmission stage, such that a particularly compact structure is observed. This is also due to the fact that the axis 10 of the drive wheel 8 and the axis, formed by the bearing pin 4, of the pivot lever 5 are arranged largely perpendicular to each other. Furthermore, the design is such that the electric motor 6 together with its output shaft and the pinion 7 thereon describe a predominantly right-hand angle of engagement in comparison to the drive wheel 8 with the crown toothing 8a. In addition, the electric motor 6, together with its output shaft and the pinion 7 in question, has a longitudinal extension which forms an acute angle a with the axis of the pivot lever 5 or the bearing pin 4 defining the axis. This is best understood from the illustration on the right in FIG. 2. The angle a may assume values from 10° to 40°.

It can be seen that the spiral contour 9 in an undeflected end position of the pivot lever 5 at least partially overlaps the pivot lever 5. This is illustrated in FIG. 1. In fact, the end position of the pivot lever 5 in question corresponds to the fact that the pivot lever 5 in this case rests with its head-side stop 5a on a low point of the spiral contour 9. In contrast, the spiral contour 9 with its highest point overlaps the pivot lever 5. In this undeflected end position of the pivot lever 5, a stop is automatically provided for the electromotive drive 6, 7, 8.

In order to achieve and implement particularly economical production, according to the exemplary embodiment, at least the drive wheel 8 and the actuating element or the pivot lever 5 are each designed as plastic injection-molded parts. In principle, the pinion 7 on the output shaft of the electric motor 6 can also be designed as a plastic injection-molded part. This not only results in economical production, but also an overall low weight is observed. In addition, there are low frictional forces.

Comparable advantages and effects are observed in the variant shown in FIG. 3. Instead of the spiral contour 9 therein, a toothed contour 11 is provided on the drive wheel 8 in order to be able to act upon the actuating element 5 or the pivot lever or the release lever 5 as shown in FIG. 1. In fact, by means of the actuating element or pivot lever 5, the locking mechanism 2, 3 can be opened in a way similar to the previously described variant. It can be seen that, for this purpose, in the exemplary embodiment according to FIG. 3, a transmission lever 14 is additionally implemented, which is also basically unnecessary.

In the variant according to FIG. 3, the toothed contour 11 is specifically designed as a central pinion 11 which is provided on the same side or surface as the crown gear 8a of the drive gear 8. A gear wheel arch 12 on the actuating element or pivot lever 5 meshes with the central pinion 11. This causes pivoting movements by the pivot lever or the actuating element 5, which can be limited as required by means of a stop 13 on the actuating element 5. The pivoting movements of the actuating element 5 are then in turn transmitted to the transmission lever 14 or act thereon.

It can be seen that the electric motor 6 including the pinion 7 is arranged in its longitudinal extension defined thereby relative to the drive wheel 8 and the crown gear 8a such that the relevant longitudinal extension is directed towards the center of the drive wheel 8. This applies to all variants.

Furthermore, the longitudinal extension in question in the variant according to FIG. 3 is predominantly oriented tangentially compared to the gear wheel arch 12.

### LIST OF REFERENCE SIGNS

1 Motor vehicle latch
2 Rotary latch
3 Pawl
4 Bearing pin
5 Actuating element
6 Electric motor
7 Pinion
8 Drive wheel
8a Crown toothing
9 Spiral contour
10 Axis
11 Toothed contour
12 Gear wheel arch
13 Stop
14 Transmission lever

1. A drive unit for motor vehicle applications, comprising an electromotive drive comprising an electric motor,
a drive wheel,
an actuating element acted upon by the drive wheel, and
a crown gear transmission stage is implemented between a pinion on an output shaft of the electric motor and the drive wheel,
wherein the drive wheel has a spiral contour and/or a toothed contour for acting upon the actuating element.

2. The drive unit according to claim 1, wherein the drive wheel comprises a crown toothing on a first respective surface of the drive wheel, and wherein the spiral contour is provided on a second respective surface of the drive wheel opposite the first respective surface of the drive wheel equipped with the crown toothing.

3. The drive unit according to claim 2, wherein the toothed contour is provided on the first respective surface of the drive wheel equipped with the crown toothing.

4. The drive unit according to claim 1, wherein the actuating element is designed as a pivot lever mounted to rotate about an axis of the pivot lever.

5. The drive unit according to claim 4, wherein the axis of the pivot lever is defined by a bearing pin, standing vertically on a housing cover.

6. The drive unit according to claim 4, wherein the pivot lever rests with a stop on a head side of the pivot lever against the spiral contour.

7. The drive unit according to claim 1, wherein the spiral contour in an undeflected end position at least partially overlaps the pivot lever.

8. The drive unit according to claim 7, wherein an axis of the drive wheel and the axis of the pivot lever are arranged perpendicular to each other.

9. The drive unit according to claim 1, wherein the electric motor with the output shaft and the pinion thereon forms a right-hand angle of engagement with the drive wheel with the crown toothing.

10. The drive unit according to claim 1, wherein the electric motor with the output shaft has a longitudinal extension which is aligned in a direction of a center of the drive wheel.

11. The drive unit according to claim 4, wherein the electric motor with the output shaft has a longitudinal extension which forms an acute angle with the axis of the pivot lever.

12. The drive unit according to claim 1, wherein the drive wheel and the actuating element are each designed as plastic injection-molded parts.

13. The drive unit according to claim 1, wherein the actuating element includes a gear wheel arch, and wherein the electric motor with the output shaft has a longitudinal extension which is oriented tangentially in comparison to the gear wheel arch on the actuating element.

14. The drive unit according to claim 1, wherein the actuating element acts upon a transmission lever of a motor vehicle latch.

15. A motor vehicle latch, comprising the drive unit according to claim 1, and a locking mechanism acted upon by the drive unit.

16. The drive unit according to claim 8, wherein the spiral contour is a helical spiral surface wound around an axis of the drive wheel.

17. The drive unit according to claim 4, wherein the toothed contour of the drive wheel interacts with an associated toothed contour on the pivot lever, wherein an axis of the drive wheel and an axis of the pivot lever run parallel to one another.
